(19) United States
(12) Patent Application Publication
(10) Pub. No.: US 2013/0146109 A1
(43) Pub. Date: Jun. 13, 2013

(54) In-place recirculatory draft beer line cleaning system

(71) Applicant: Ian Daniel Cavilia, Glastonbury, CT (US)

(72) Inventor: Ian Daniel Cavilia, Glastonbury, CT (US)

(21) Appl. No.: 13/524,398

(22) Filed: Jun. 15, 2012

Related U.S. Application Data
(60) Provisional application No. 61/525,816, filed on Aug. 21, 2011.

(51) Int. Cl. B08B 9/032

(52) U.S. Cl. CPC B08B 9/032
USPC 134/56 R

(57) ABSTRACT

Automated system for cleaning conduits used for dispensing draft beer from taps. The system uses various sensors, valves, and a microprocessor-based controller to automate the process with little user intervention. This apparatus is permanently installed in a retail establishment and connected to the dispensing system by way of fittings designed to mate with standard keg couplers currently used in such systems.

### FIELD OF THE INVENTION

The invention relates to the field of draft beer line cleaning systems.

### BACKGROUND ART

Over time, conduits for dispensing beer in retail establishments accumulate deposits of contaminants from the product traveling through them. These contaminants are chiefly yeast deposits and calcium oxalate, also known as “beer stone.” The abundance of these contaminants can affect the performance of the dispensing system itself, as well as result in deterioration in the taste and appearance of the product. It can also affect the product's healthfulness. For this reason, public health departments in many jurisdictions require retail establishments to comply with a specified periodic cleaning regime.

In order to maintain beer lines so they perform optimally, deliver an end product that is pleasing to discerning consumers, and satisfy local public health department regulations where applicable, routine cleaning, using chemical agents designed specifically for this purpose, is necessary. Such chemical agents of adequate design are presently commercially available and several methods of executing the cleaning process are already widely in practice.

Some of these methods involve propelling the chemical agents through the beer lines by means of pressurized gas, then permitting the agents to remain in place statically for a period of time before rinsing them out of the system. Other methods, chiefly used for cleaning lines that measure over thirty feet in length, involve circulating the chemical agents through a loop formed by two lines: Flowing through one in the forward direction and the other in the reverse direction. (This loop method has proven to be the most effective means of cleaning lines of these lengths.)

Presently, the apparati for accomplishing this procedure are cumbersome. The procedure itself is complex and is therefore normally delegated to dedicated professionals hired for the task by owners of the beer dispensing establishments. This invention is a fully automated method that is permanently installed. It can be operated by the establishment's permanent staff, using a few simple steps easily learned in a brief training procedure, thereby eliminating the need for hiring outside personnel and having them enter the establishment with their cumbersome cleaning equipment.

### SUMMARY OF THE INVENTION

The present invention is a fully automated, permanently installed system for cleaning beer dispensing conduits. It connects to the beer dispensing conduits via fittings already mounted in the retail establishment. All the components necessary to operate the cleaning system are contained within a single unit that is intended to be mounted on the wall outside the refrigerator compartment where the kegs are stored. It is connected to existing electricity and to hot and cold running water, and to a drain connected to the sewage system.

Two conduits emanating from the unit enter the refrigerator space where they are connected to fittings mounted on the wall of the refrigerator. These fittings are designed to mate with couplers designed for attaching to beer kegs. These two lines are designated “feed” and “return.”

Prior to commencing the cleaning process, the couplers (which are attached to the beer kegs when dispensing is taking place) are attached to the fittings. At least one line must be connected to the “feed” and one to the “return” in order to form a complete loop, but multiple pairs of lines may be connected. The faucets at the end of these lines are joined together by means of a jumper hose, with boots for fitting to the spouts.

The automated process is initiated by means of the user interface located on the cleaning system unit. Once the process begins, the microprocessor assumes control of all operations until the cleaning operation is completed. The controller monitors various sensors, including two pH sensors, a turbidity sensor, a thermistor, and a pressure transducer. It controls valves and the pump motor throughout the process. Using software algorithms, every stage of the process is performed until the sensors detect that the desired state has been achieved. Adverse conditions during the cleaning process can be detected and the user can be notified.

The automated process consists of several stages. Each stage is either time-controlled or sensor-controlled. Sensors confirm that the desired condition has been achieved. In the first stage, cold water forces beer from the lines until the pH at both ends of the line indicates all the beer has been purged. In the second stage, a mixture of water and cleaning agent is recirculated through the lines in order to remove contaminants. A sensor measures the turbidity of the fluid to determine when it has dissolved all the contaminants. In the third stage, water is used to rinse the cleaning agent from the system. The pH sensors provide assurance that all of the toxic cleaner is thoroughly removed so that it is safe to resume dispensing beer. In the fourth and final stage, compressed gas is introduced to remove the water and to thoroughly dry the lines to prevent any dilution of the beer.

### DESCRIPTION OF THE DRAWINGS

FIG. 1 Illustrates the components housed inside the unit, mounted on a wall

FIG. 2 Illustrates the unit in relation to the dispensing system, when connected

### DETAILED DESCRIPTION

The invention consists of a number of components, most of them housed in a box-like enclosure (the “Unit”), which in one embodiment would be attached to a wall of the establishment, outside the walk-in refrigerated space where beer kegs are normally stored while beer is dispensed from them through flexible lines (“conduits”). Pipes or lines from the unit extend through the wall into the refrigerated space, terminating in connectors suitable for connection to the conduits which are connected to the kegs while beer is being dispensed.

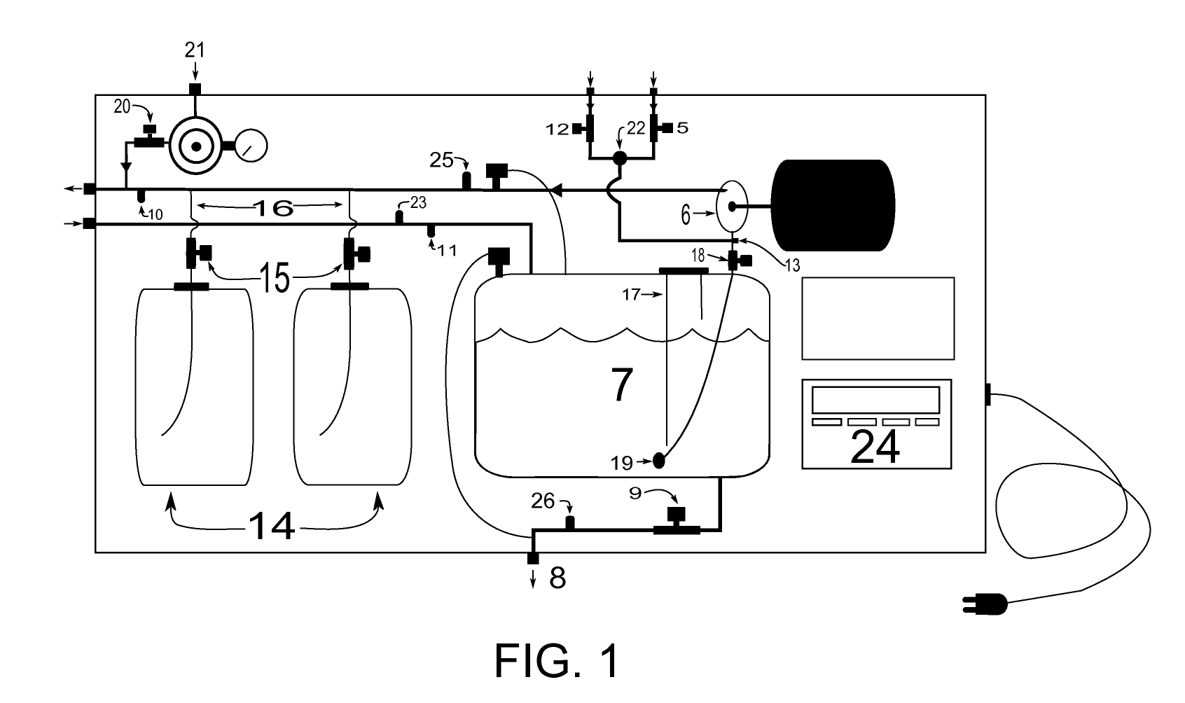

The components housed inside the Unit include the following:
A controller (FIG. 1, 24), comprising a control panel and display and a microprocessor-based control unit which, based on inputs from multiple sensors in the unit as well as inputs to the control panel by the operator, controls the opening and closing of several valves, as well as the operation of a motor driving a pump. The controller also monitors all sensors at every stage of the process to detect faults and stop operation or notify the user if any occur.
a motor-driven pump (FIG. 1, 6), with a control circuit allowing its speed to be varied as directed by the controller. In one embodiment this would comprise an alternating-current motor controlled by a variable-frequency drive, with input to the controller provided by a pressure transducer on the output side of the pump. The control of the pump by way of a pressure transducer (FIG. 1, 25) assures that the pump will not be run at speeds which would produce damagingly high pressures in the Unit or the lines being cleaned. The suction side of the pump is connected to the tank, so that cleaning solution held in the tank when it operates as a reservoir during recirculatory cleaning may be drawn from the tank and pumped through the feed line under pressure, to circulate through the two linked lines being cleaned. The suction side of the pump is also connected to the combined water intake from the hot and cold water lines, so that it can be used to force water through the loop of conduits during the initial flushing phase of the process, and later during the preparation for the cleaning phase, when water is being brought up to temperature in preparation for mixing with cleaning solution. Solenoid-operated valves controlled by the controller select whether the pump draws from the water lines or the tank, depending on the phase of the process under way at the time.
A thermistor (FIG. 1, 13) in the intake line from the water supply to the pump, to sense the temperature of the water coming from the mixing valve, signaling the control unit at the proper time to open the valve from the cleaning solution tank and begin the mixing of cleaner and water.
pipes connected to hot and cold domestic water supply, with solenoid-operated valves (FIGS. 5, 5 and 12) for each line. The hot and cold water lines come together in a thermostatically-controlled mixing valve (FIG. 1, 22), to allow the provision of water at the proper temperature for mixing with cleaning solution during the cleaning phase of the process.
supply tanks (FIG. 1, 14) for two types of cleaning solutions (a caustic solution, normally used, and an acid, used on a less frequent basis for more vigorous cleaning), each of which is connected to the “feed” line of the cleaning loop through a solenoid-controlled valve (FIG. 1, 15) and a venturi tube (FIG. 1, 16) which facilitates drawing the solution into the line and automatically mixing it with water in the proper proportion when the valve is opened.
A tank (FIG. 1, 7) for receiving and then draining beer and water flushed from the conduits during the first phase of the cleaning process, for holding a reservoir of a mixture of cleaning solution and water during the recirculatory cleaning phases, and for receiving and then draining the spent cleaning solutions and the final rinse water. The tank has a connection to the suction side of the pump (the discharge side of the pump is connected to the feed line) through a dip tube with a filter (FIG. 1, 19) and a valve (FIG. 1, 18). The tank also has a connection to the return line, and it has a drain connected to the sewage system. All connections have solenoid valves controlled by signals from the controller.
feed and return lines, each of which, in use, is connected to at least one beer conduit. Multiple pairs of conduits may be cleaned in one operation, if more than one conduit is connected to the Unit's lines by way of manifolds. The two conduits in each pair are connected at their faucet ends by a hose, creating a loop (or loops) for recirculation and flushing.
solenoid valves on each of the various lines, each controlled by the controller during the various phases of the process.
Two pH sensors, one on the feed line (FIG. 1, 10) and one on the return line (FIG. 1, 11). Output from the pH sensors is fed to the controller during each phase of the process in which a substance in the lines is being replaced by another substance (including the first phase, when water is being used to flush beer out of the lines; the beginning of the cleaning phase, when a mixture of cleaning solution and water is replacing the water; and the rinse phase, when plain water is flushing out the cleaning solution). At each such phase, a comparison of the “before” and “ after” readings allows the controller to determine when the material being introduced has completely replaced the previous material.
A turbidity (cloudiness) sensor (FIG. 1, 23) on the return line. The output from the turbidity sensor is fed to the controller during the cleaning-solution phase of the process. The controller tracks the change in turbidity readings as the cleaning process proceeds, and determines to terminate that phase of the process when the reading has not increased for a specified length of time, thus indicating that all the contaminant material has been removed from the interior surface of the lines and is now suspended in the cleaning solution.
A gas inlet (FIG. 1, 21), equipped with a connector to connect to a source of pressurized gas (which may be carbon dioxide, nitrogen, a “beer gas” blend, or compressed air), and also equipped with a regulator to control the pressure admitted into the conduits, and a valve (FIG. 1, 20) controlled by the controller. Gas is used to purge the final rinse water from the conduits, leaving the lines empty so they can be re-connected to the beer kegs.
A conductivity probe (FIG. 1, 26) in the drain line exiting from the tank, to signal the controller when there is no liquid in the drain line, thus indicating that the purging gas has forced all the rinse water from the lines.
The system also includes one or more jumper hoses used to connect the faucet ends of the pairs of lines being cleaned.

The following is a step-by-step description of the process:

### Set-Up Preparation

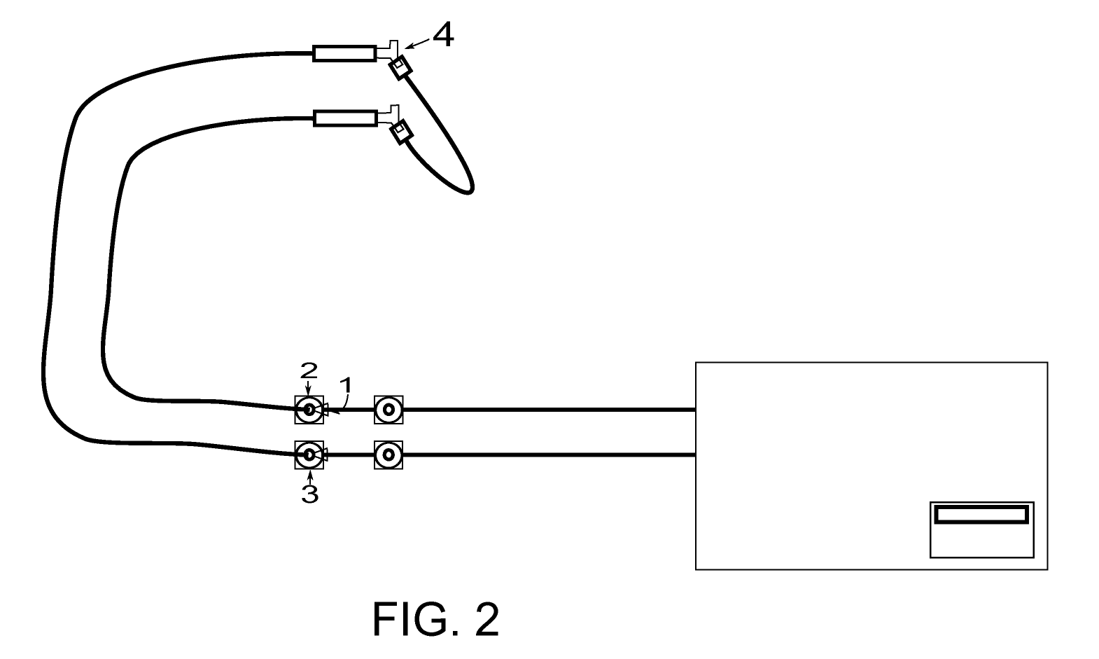

Prior to starting the automated process, the operator dis-connects the keg coupler (FIG. 2, 1) (which, when beer is being dispensed, connects a keg to a conduit which carries beer to a dispensing faucet) from at least one keg. This keg coupler is then connected to one of the FEED fittings (FIG. 2, 2) that extend from the Unit and are installed on the wall inside the refrigerator. At least one other conduit (FIG. 2, 1) is similarly dis-connected from a keg and connected to one of the RETURN fittings (FIG. 2, 3). Multiple pairs of conduits may be connected to the Unit in this manner, depending on the number of connectors available on the manifolds that have been custom fitted when the device is installed. Note that the number of lines that may be attached for a single cleaning session must be an even number, as feed and return conduits must be linked in pairs. The faucets (taps) (FIG. 2, 4) of each of these pairs of lines are joined together using a hose (jumper hose) with boots designed to fit the nozzles of the said faucet, and the faucets are then opened. The system is now ready to begin operation. The operator presses a button on the user interface panel of the unit to begin the process. Please note that in the description that follows, any reference to “a” conduit or “one” conduit may include more than one such conduit, if multiple pairs of conduits are connected for a single cleaning session.

### Beer Purging

During the first stage of the cleaning process, the cold water solenoid valve (FIG. 1, 5) is opened to allow cold municipal water to enter the system under line pressure. The pump (FIG. 1, 6) is energized to boost the pressure of the water, forcing it through one conduit, out the faucet, through the jumper hose, into the other faucet, through its conduit, back into the Unit's return line, and into the tank (FIG. 1, 7). This action forces the beer contained in the conduits to exit through the drain (FIG. 1, 8), because the solenoid valve (FIG. 1, 9) on the tank's drain remains open during this stage to allow for drainage. A pH sensor (FIG. 1, 10) on the feed line measures the pH of the incoming water while another pH sensor (FIG. 1, 11) on the return line measures the pH of the fluid approaching the tank and drain. When all of the beer has been purged and clean water reaches the pH sensor (FIG. 1,11), the readings of the two sensors (FIG. 1,10 and 11) will match, signaling the microprocessor to end this stage of the process and to proceed to the next.

### Cleaner Charge

During the second stage of the process hot and cold water are drawn into the system, and mixed by a mixing valve until the desired temperature is reached, after which cleaner compound is introduced into the water stream, producing a properly-mixed water-cleaner solution, which will be recirculated through the lines to achieve the cleaning effect. First the hot water solenoid valve (FIG. 1, 12) is opened to allow hot municipal water to mix with the cold water already present following stage one, in order to produce the lukewarm temperature that is best suited to the cleaning process. A thermostatically-controlled mixing valve regulates the proportions of hot and cold water, automatically adjusting as the desired temperature is approached. During this phase, the drain valve is open, allowing the initial low-temperature water to drain out. A thermistor (FIG. 1, 13) on the intake water line just prior to the pump measures the temperature of the water until it reaches the target value, at which time the dispensing of cleaner compound begins.

The cleaning compounds are stored in reservoirs (FIG. 1, 14). Two reservoirs are provided to accommodate the two types of cleaning solutions regularly used. One of the reservoirs is selected at the control panel by the operator at the start of the process. The cleaner is admitted into the system by the opening of one of the solenoid valves (FIG. 1,15) on the lines from the cleaner tanks to the feed line, which allows the pressure differential created by the water flow to draw it in via venturi tubes (FIG. 1, 16). The two pH probes (FIG. 1, 10 and 11) monitor the pH at both ends, as before during the flush phase.

During this sub-phase, when plain water in the lines is being replaced by water-cleaner solution, the drain valve remains open, allowing the water to exit the system. When the readings of both pH probes (FIG. 1, 10 and 11) match, indicating that cleaner has reached the end of the loop, the drain solenoid (FIG. 1, 9) is closed, to allow the solution to fill the tank (FIG. 1,7). A conductivity probe (FIG. 1,17) signals when the tank is full, prompting the controller to stop the incoming flow of water by closing solenoid valves (FIG. 1, 5 and 12), and the next stage of the process is ready to begin.

### Recirculating

During the third stage the water-cleaner solution recirculates in order to remove the contaminants from the beer lines. A solenoid valve (FIG. 1, 18) is opened to allow the pump (FIG. 1, 6) to draw fluid from the tank (FIG. 1, 7). The intake pipe in the tank, through which the solution is drawn into the pump, is equipped with a filter, to prevent larger solid particles that may be dislodged from the lines from repeatedly recirculating through the lines being cleaned. (FIG. 1, 19).

The water-cleaner solution travels in a continuous loop from the tank (FIG. 1, 7). The solution is propelled by the pump (FIG. 1, 6) through the feed line, out one faucet, through the jumper hose, into the other faucet, and back through the return line, whence it returns to the tank (FIG. 1, 7). A turbidity sensor (FIG. 1, 23) monitors the turbidity (cloudiness) of the water-cleaner solution. As contaminants are dissolved from the walls of the conduits by the cleaner, the solution will become increasingly cloudy (turbid). Once the turbidity ceases to increase, a stabilization of the readings for a pre-specified period of time indicates that the solution has accumulated all of the soil and contaminants that the solution is capable of dissolving from the lines. At this point, the recirculating stage is complete and the next stage begins.

### Rinsing

The fourth stage uses clean water to rinse the cleaning agent completely from the beer lines. Solenoid valves (FIG. 1,5 and 12) are opened to allow fresh water to enter. The drain valve (FIG. 1, 9) is opened, allowing first the spent cleaning solution, and then the rinse water, to exit the tank via the drain (FIG. 1, 8). The two pH probes (FIG. 1, 10 and 11) again monitor the pH of the solution and water in the feed and return lines. When the readings match, this indicates that all of the cleaner has been thoroughly rinsed from the line, and replaced by plain water. This assures that it will be safe to dispense beer through the lines without fear of contamination by cleaner remnants.

As an additional stage of the rinse cycle, the tank must be rinsed out thoroughly with water, so that no cleaner or contaminants remain in the tank. The drain valve is closed, and water is allowed to continue running into the tank until the level probe indicates that the tank is full. Then the drain valve is opened, and the tank empties. This fill-and-drain sequence is repeated several times.

A final step in the rinse process is a reverse flushing of the filter (FIG. 1, 19). The cold-water valve (FIG. 1,5), the tank valve (FIG. 1, 18), and the drain valve (FIG. 1, 9) are all opened. This allows clean water to flow through the tank inlet line, but in the opposite direction from the direction the water-cleaner solution ran during the cleaning procedure. This will flush particulates from the inlet side of the filter screen, and out the open drain pipe, leaving the filter screen clean and unobstructed in preparation for the next cleaning run.

### Drying

The fifth and final stage dries the beer lines, using compressed gas to purge the water from the lines. The pump (FIG. 1, 6) is shut off and valves (FIG. 1, 5 and 12) are closed in order to stop all flow of liquids. A solenoid valve (FIG. 1, 20) is opened to allow compressed gas from the inlet (FIG. 1, 21) to enter the lines, forcing water out through the drain (FIG. 1, 8). A regulator (FIG. 1, 22) reduces the pressure of the incoming gas.

The gas pressure is provided by an external source. The gas can be either carbon dioxide, nitrogen, a “beer gas” blend, or compressed air, depending on what is conveniently available.

A conductivity probe (FIG. 1, 26) detects the presence of water in the drain stream. When it detects a loss of conductivity within the drain pipe, this is an indication that all water has been purged from the system, and only gas is flowing through the lines. The gas is allowed to continue to run for a prescribed period of time in order to evaporate any remaining water in the lines. Once this has been completed, the valve (FIG. 1, 20) is closed and the cleaning process is complete. The keg couplers can now be removed from the fittings and re-connected to the kegs, and the system put back into service dispensing beer. The cleaning unit is now ready for another cycle at any time, so long as the cleaning solution supply tanks contain an adequate supply.

What is claimed is:

1. A means for automated cleaning of beer dispensing conduits, consisting of
a microprocessor-based controller
a reservoir tank for recirculatory cleaning
tanks of cleaning agents,
a pump to circulate flushing and cleaning agents through the conduits to be cleaned.
pipes or lines to connect to water supply lines, the conduits to be cleaned, and a drain valves on the various lines, controlled by the controller
sensors for control of various functions, which provide input to the controller.

2. The apparatus of claim 1, further including a means for permanently installing the apparatus in an establishment.

3. The apparatus of claim 2, further incorporating a means by which all electrical and plumbing components of the invention are contained in a single cabinet that can be installed in the establishment.

4. The apparatus of claim 1, wherein the controller includes software algorithms to monitor the sensors at all times during use in order to detect various kinds of faults.
